(19) United States
(12) Patent Application Publication
(10) Pub. No.: US 2003/0076536 A1
(43) Pub. Date: Apr. 24, 2003

(54) Digital binders, methods for replicating the same with physical binders, and binder systems incorporating the same

(76) Inventor: Martin Daffner, Corona del Mar, CA (US)

Correspondence Address: Eric K. Satermo, P.O. Box 19099, Irvine, CA, 92623-9099, US

(21) Appl. No.: 10/201,614

(22) Filed: Jul. 22, 2002

Related U.S. Application Data
(60) Provisional application No. 60/307,709, filed on Jul. 24, 2001.

(51) Int. Cl. B42F 3/00; G06F 13/00; G06F 3/12

(52) U.S. Cl. 358/1.16; 402/4

(57) ABSTRACT

A binder includes both physical content and digital content. The physical content is printed on sheets retained by the binder, and the digital content is stored on a memory associated with the binder. The digital memory may be interfaced with a computerized device, such as a personal computer or a portable electronic device. The digital memory may be a portable memory device such as a memory card or a dedicated device incorporated within the binder. The digital content represents the physical content as accurately as possible so that when viewed on a computerized device with a display, the physical content is accurately represented. The digital content may be modified by a user with a computerized device, with the modified pages being subsequently printed out so that the physical content is replicated with the modified digital content. Accordingly, the binder provides the benefits of a binder with both physical content that is tangible, familiar, and comfortably viewed and digital content that is easily transmitted and modified electronically.

### CROSS REFERENCE TO RELATED APPLICATIONS

The present application claims priority under 35 U.S.C. §119(e) on U.S. Provisional Application for Patent Serial No. 60/307,709 filed Jul. 24, 2001.

### BACKGROUND OF THE INVENTION

The present invention relates to document management in general and, more particularly, to managing files in both physical and digital format. The present invention also relates to binders, particularly binders that are configured to interface with an electronic appliance such as a personal digital assistant (PDA) or other portable information device.

Documentation in the workplace—both physical (i.e., paper or hardcopies) and digital (i.e., computer or digital files)—is so ubiquitous that many people take for granted the amount of time and money that is actually expended in the management of documents. However, to those who are charged with increasing the efficiency and productivity of the office, document management is a top concern and an area where improvement is continually sought after and highly prized.

One specific realm of document management concerns the accuracy of a digital file stored in memory on an electronic device such as a computer and its corresponding hardcopy equivalent stored in an actual file or a binder. In other words, it is important to know that the paper copy filed in a binder is the latest version and the exact hardcopy duplication of the corresponding digital file, and vice versa. This correspondence between a hardcopy and its digital equivalent is known as “hot sync” or replication.

There is a need in the art for methods and apparatus that enable easy replication of hardcopy and digital files.

### SUMMARY OF THE INVENTION

A binder storage system for storing both physical and digital content may include a shelf unit including a plurality of docks, a plurality of binders for storing physical content, and a computer in communication with each of the docks of the shelf unit. Each of the binders may include a memory module for storing digital content and an interface for engaging mechanically and electrically with one of the docks of the shelf unit. The computer may be configured to store digital content corresponding to the digital content stored in the memory modules. Additionally, the computer may be configured to replicate the digital content stored in the memory modules when the digital content stored in the memory modules is different from the corresponding digital content stored in the computer.

In addition to replicating digital content, the computer may be configured to print a hardcopy of digital content that is replicated at a printer. The computer may also print indicia upon the hardcopy for indicating which of the binders the hardcopy corresponds to, thereby facilitating filing. The computer may also provide a signal indicative of which binder the hardcopy corresponds to, for example, actuating a light on the binder or the dock. Further, the computer may display the digital content in a manner which substantially duplicates the physical content stored by the binders.

Each of the memory modules may be removable from the binders. Accordingly, a user may removable a memory module from one of the binders and then connect the module with a computer device, such as a portable computerized device. The digital content may then be modified by the portable device, and the memory module may then be replace on the binder. The computer than then replicate the digital content stored on the computer with the modified digital content.

### BRIEF DESCRIPTION OF THE SEVERAL VIEWS OF THE DRAWINGS

FIGS. 1A to 1E are schematic views of a replicating physical/digital binder system of the invention;

FIG. 2 is a block diagram of an exemplary binder of the invention;

FIG. 3 is a is a block diagram of an exemplary portable electronic device of the invention;

FIG. 4 is a block diagram of an exemplary computer system of the invention;

FIG. 5 is a schematic view of a binder and a computer system where the physical content of the binder is duplicated on a display of the computer system;

FIG. 6 is a block diagram of a binder system of the invention;

FIG. 7 is a flow chart illustrating exemplary methodology of the invention; and

FIG. 8 is a plan view of hardcopy of the invention.

### DETAILED DESCRIPTION OF THE INVENTION

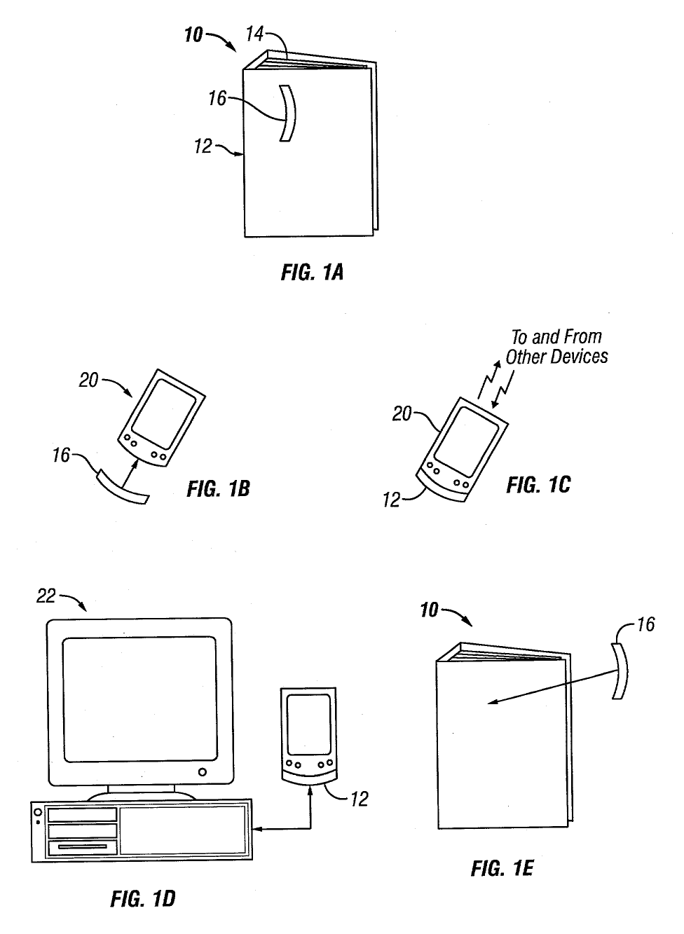

Referring more particularly to the drawings, apparatus and associated methodology for replicating digital and physical documents are illustrated in accordance with a preferred embodiment in FIGS. 1A to 1E. An exemplary replicable binder 10 of the invention as shown in FIG. 1A includes a body 12 for storing both physical content and digital content. The physical content may be hardcopies printed on sheets of paper 14 retained by the binder 10, and the digital content may be stored on a memory module 16 associated with the binder 10.

In accordance with an exemplary embodiment of the invention, the digital memory module 16 may be interfaced with a computerized device, such as a portable electronic device 20 shown in FIGS. 1B and 1C or a personal computer as shown in FIG. 1D. The digital memory module 16 may be either a portable memory device as shown in FIG. 1B such as a memory card or a dedicated device incorporated within the binder (not shown in the drawings but as disclosed in U.S. patent application Ser. No. 09/732,521, the entire disclosure of which is incorporated herein by reference). Once interfaced with an electronic device, the digital content may be sent to other electronic devices, or may be augmented by receiving additional content from other electronic devices, as shown in FIG. 1C.

The digital content represents the physical content as accurately as possible so that when viewed on a computerized device with a display, such as the portable device 20 or a desktop computer system 22 as shown in FIG. 1D, the physical content is accurately represented. The digital content may be modified by a user with a computerized device 20 or 22, with the modified pages being subsequently printed out so that the physical content is replicated with the modified digital content. The modified digital content stored on the memory module 16 may then be replaced on the binder 10 as shown in FIG. 1E. Accordingly, the replicable binder 10 provides the benefits of a binder with both physical content that is tangible, familiar, and comfortably viewed and digital content that is easily transmitted and modified electronically.

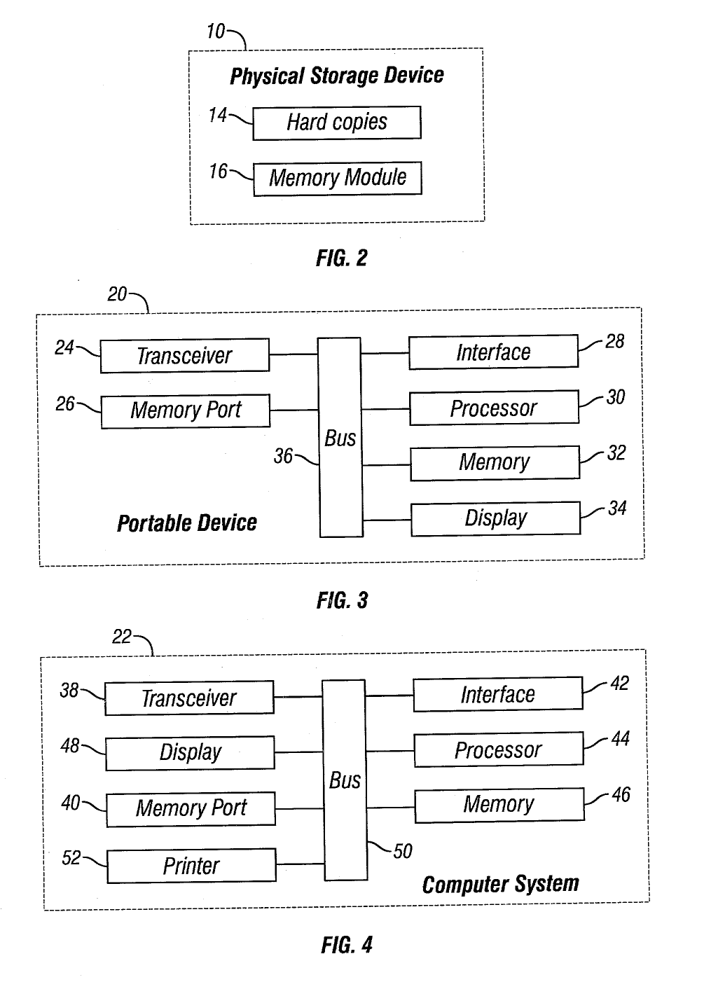

Referencing FIG. 2, an exemplary replicable binder 10 of the invention may include both physical content in the form of hardcopies 14, which may include sheets of paper, tab dividers, and so on, and digital content stored on the memory module 16, which digital content corresponds to the physical content stored in the binder 10.

Referencing FIG. 3, an exemplary portable electronic device 20 of the invention may include one or more data portals for receiving and transmitting digital content, such as a transceiver 24 configured to transmit and receive data wirelessly and/or a memory port 26 configured to engage with the memory module 16 (e.g., as shown in FIGS. 1B and 1C). The portal electronic device 20 may also include a user interface 28, a processor 30, an on-board memory 32, and a display 34. A system bus 36 may be provided for communication on the device 20. Examples of portable electronic devices include portable digital assistants (PDAs), pocket PCs, Microsoft Tablet, and so on

An exemplary computer system 22 is shown in FIG. 4 and may include data portals such as a transceiver 38 and a memory port 40 analogous to that described above. In addition, the computer system 22 may include a user interface 42, a processor 44, a memory 46, a display 48, and a communication bus 50. A peripheral such as a printer 52 may be provided for producing hardcopies of the physical content.

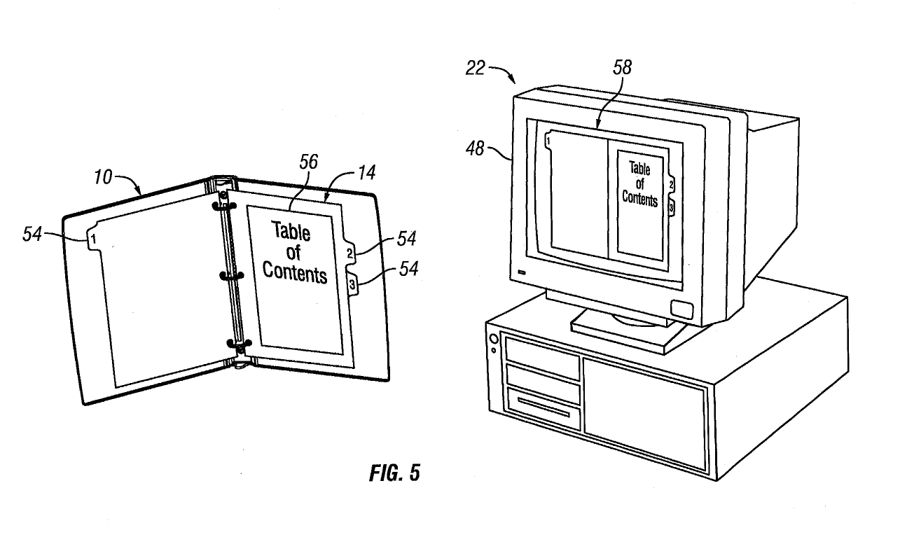

In accordance with the present invention, the digital content displayed by the portable electronic device 20 on the display 34 (or the computer system 22 on display 48) substantially duplicates or accurately reflects the actual physical content 14 retained in the binder 10. More specifically, as shown in FIG. 5, if, for example, the physical content 14 of the binder 10 includes index dividers 54 and paper sheets 56, then the displayed digital content 58 may include graphics duplicating on the display 48 index dividers and paper sheets.

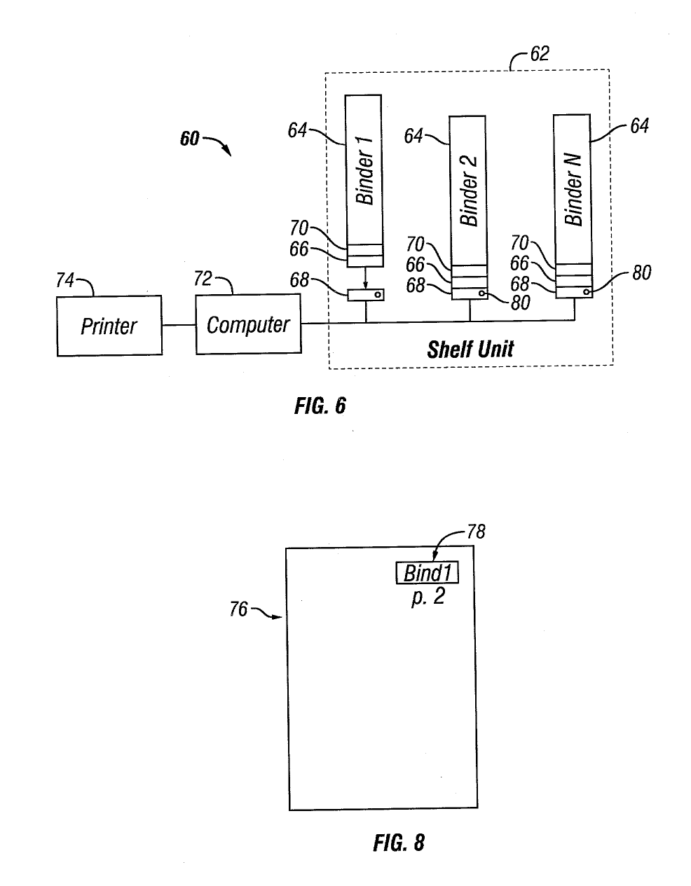

According to a number of embodiments as shown in FIG. 6, a binder storage system 60 may include a shelf unit 62 configured to hold a plurality of binders 64. Each binder may include an interface 66 for mechanically and electrically releasably engaging with a complementary dock 68 of the shelf unit 62. Each interface 66 may be in communication with a memory module 70 of the binder 64, and each dock 68 may be in communication with a computer 72.

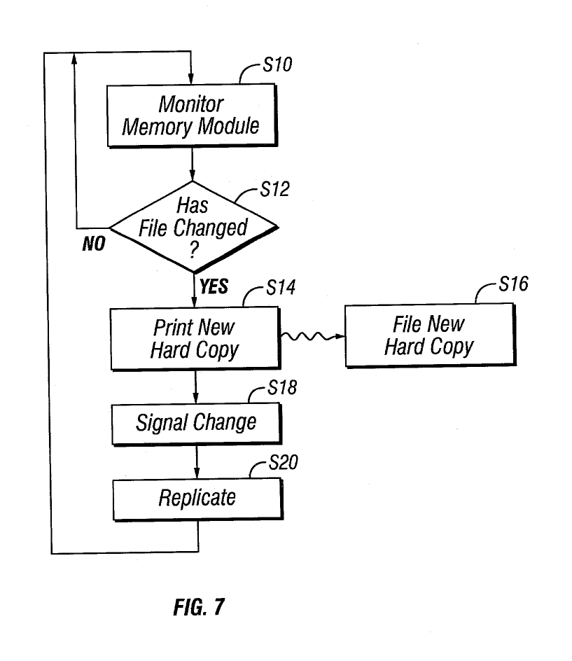

With additional reference to FIG. 7, the computer 72 may be configured to monitor the memory modules 70 of each binder 64 (step S10). If digital content stored in the computer 72 or if the digital content stored on the memory module 70 has been modified (step S12), then the computer 72 may print out a new hardcopy corresponding to the modified digital content at a printer 74 (step S14). As shown in FIG. 8, the new hardcopy 76 may include indicia 78 printed thereon to indicate to a user where to file the new hardcopy (step S16). The computer 72 may also provide a signal (step S18), for example, a light 80, at the dock 68 with which the binder 74 is engaged, to indicate where a new hardcopy 76 is to be filed. The computer 72 may then replicate or “hot sync” the latest modified version of the digital content stored on the computer 72 and on the memory module 70.

Those skilled in the art will understand that the preceding exemplary embodiments of the present invention provide the foundation for numerous alternatives and modifications thereto. These and other modifications are also within the scope of the present invention. Accordingly, the present invention is not limited to that precisely as shown and described above but by the scope of the appended claims.

What is claimed is:

1. A binder storage system for storing both physical and digital content, the system comprising:
a shelf unit including a plurality of docks;
a plurality of binders for storing physical content, each of the binders including a memory module for storing digital content and an interface for engaging mechanically and electrically with one of the docks of the shelf unit; and
a computer in communication with each of the docks of the shelf unit for:
storing digital content corresponding to the digital content stored in the memory modules; and
replicating the digital content stored in the memory modules when the digital content stored in the memory modules is different from the corresponding digital content stored in the computer.

2. The binder storage system of claim 1 wherein the computer causes a printer to print a hardcopy of digital content that is replicated.

3. The binder storage system of claim 2 wherein the computer causes indicia to be printed upon the hardcopy for indicating which of the binders the hardcopy corresponds to.

4. The binder storage system of claim 2 wherein the computer provides a signal indicative of which binder the hardcopy corresponds to.

5. The binder storage system of claim 4 wherein each of the docks includes a light, the signal being an actuation of the light.

6. The binder storage system of claim 1 wherein the memory module of one at least one of the binders is removable.

7. The binder storage system of claim 4 wherein the removable memory module interfaces with a portable computerized device.

8. The binder storage system of claim 1 wherein the computer includes a display, the computer for displaying the digital content in a manner which substantially duplicates the physical content.

9. A method for storing physical and digital content, the method comprising:
providing a shelf unit including a plurality of docks;
providing a plurality of binders for storing physical content, each of the binders including a memory module for storing digital content and an interface for engaging mechanically and electrically with one of the docks of the shelf unit;
engaging at least one of the binders with one of the docks;
causing the computer to store digital content corresponding to the digital content stored in the memory modules on the computer; and
causing the computer to replicate the digital content stored in the memory modules with the computer when the digital content stored in the memory modules is different from the corresponding digital content stored on the computer.

10. The method of claim 9 further comprising causing a printer to print a hardcopy of digital content that is replicated.

11. The method of claim 10 wherein the step of causing a printer to print a hardcopy comprises printing indicia upon the hardcopy for indicating which of the binders the hardcopy corresponds to.

12. The method of claim 10 further comprising causing the computer to provide a signal indicative of which binder the hardcopy corresponds to.

13. The binder storage system of claim 1 wherein the memory module of one at least one of the binders is removable, further comprising removing the removable memory module from the binder.

14. The method of claim 13 further comprising:
providing a portable computerized device with an interface for receiving the removable memory module; and
connecting the removable memory module to the interface of the portable device.

15. The method of claim 14 further comprising modifying the digital content on the removable memory module with the portable device.

16. The method of claim 15 further comprising reconnecting the removable memory module with the binder.

17. The method of claim 16 further comprising causing the computer to replicate the digital content stored on the computer with the modified digital content of the reconnected memory module.

18. The method of claim 17 further comprising causing a printer to print a hardcopy of the modified digital content.

19. The method of claim 9 further comprising disengaging the binder from the dock.

20. A binder system for storing physical content and digital content, the binder comprising:
a shelf unit including a plurality of docks each for communicating with a computer; and
a plurality of binders for storing physical content, each of the binders including a memory module for storing digital content and an interface for engaging mechanically and electrically with one of the docks of the shelf unit;
the digital content stored on the memory modules corresponding to digital content stored on the computer; and
the digital content stored in the memory modules being replicated when the digital content stored in the memory modules is different from the corresponding digital content stored in the computer.
